(19) United States
(12) Patent Application Publication
(10) Pub. No.: US 2026/0093282 A1
(43) Pub. Date: Apr. 2, 2026

(54) PIVOTLESS FOOT PEDAL

(71) Applicant: Doosan Bobcat North America Inc., WEST FARGO, ND (US)

(72) Inventors: Matthew Walter Keller, Bismarck, ND (US); David Glasser, Bismarck, ND (US)

(21) Appl. No.: 19/347,414

(22) Filed: Oct. 1, 2025

Related U.S. Application Data
(60) Provisional application No. 63/701,978, filed on Oct. 1, 2024.

(51) Int. Cl. G05G 1/30

(52) U.S. Cl. CPC G05G 1/30

(57) ABSTRACT

A foot pedal operator input device includes a sensor and a sensed component. A top base of the foot pedal supports a treadle apart from a bottom base. Oppositely inclined flexures extend between the bottom base and the top base. The oppositely inclined flexures are configured to constrain motion of the treadle to a rocking or rotational motion about an artificial axis, instead of about a physical pivot mechanism, with the rocking or rotational motion of the treadle changing positioning between the sensor and the sensed component such that a sensor output is indicative of the treadle position.

### CROSS-REFERENCE TO RELATED APPLICATION(S)

This application claims priority to U.S. provisional application No. 63/701,978, filed on 1 Oct. 2024, the content of which is hereby incorporated by reference in its entirety.

### BACKGROUND

The present disclosure is related to a motion transmitting mechanism, in the form of a foot pedal for a power machine, wherein the pedal has forward and rearward tilt capabilities with no pivot pin.

Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Some examples of work vehicle power machines include loaders, excavators, utility vehicles, tractors, and trenchers, to name a few. Foot pedal input devices typically include a pivot connection about which the foot pedal can be rotated. These pivot connections incur wear with use, and excessive wear can cause the neutral tolerance range of a pedal to expand outside of the programmed limits.

The discussion in this Background is merely provided for general background information and is not intended to be used as an aid in determining the scope of the claimed subject matter.

### SUMMARY

In exemplary embodiments, a foot pedal operator input device includes a sensor and a sensed component. A top base of the foot pedal supports a treadle apart from a bottom base. Oppositely inclined flexures or flat springs extend between the bottom base and the top base. The oppositely inclined flexures are configured to constrain motion of the treadle to a rocking or rotational motion about an artificial axis, instead of about a physical pivot mechanism, with the rocking or rotational motion of the treadle changing positioning between the sensor and the sensed component such that a sensor output is indicative of the treadle position.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. All descriptions are applicable to like and analogous structures throughout the several embodiments, unless otherwise specified.

FIG. 1 is a front perspective view of a power machine in the form of a skid-steered loader power machine or vehicle having foot pedals in the operator's compartment for operating the boom arm and bucket cylinders.

FIG. 2 is a left perspective view of an exemplary foot pedal of the disclosure, with a protective boot.

FIG. 3 is a right perspective view of the exemplary foot pedal, with a protective boot.

FIG. 4 is a left perspective view of the exemplary foot pedal, with the boot removed and some parts shown as transparent.

FIG. 5 is a lower right perspective view of the exemplary foot pedal.

FIG. 6 is a right side perspective view of the exemplary foot pedal.

FIG. 7 is an enlarged view of a portion of the right side of the exemplary foot pedal.

FIG. 8 is a right distal end perspective view of the exemplary foot pedal.

FIG. 9 is a distal end view of the exemplary foot pedal.

FIG. 10 is a left perspective view of the exemplary foot pedal, with some parts shown as transparent so that positions of the flexure ends are visible.

FIG. 11 is a right side view of the exemplary foot pedal in a 10 degree rearward inclination; the compression springs are not shown so that the flexures are more visible.

FIG. 12 is a right distal end view of the exemplary foot pedal in a 10 degree rearward inclination; the compression springs are not shown so that the flexures are more visible.

FIG. 13 is a right proximal end view of the exemplary foot pedal in a 10 degree forward inclination; the compression springs are not shown so that the flexures are more visible.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for case of understanding the description. It is contemplated that structures may be oriented otherwise.

The terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. Unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. The singular forms of “a,” “an,” and “the” include plural references unless the context clearly dictates otherwise.

### DETAILED DESCRIPTION

The disclosed exemplary foot pedal is configured for forward and rearward tilt capabilities with no pivot pin. Two compression springs are located on the longitudinal axis. Compliant links in the form of flat springs of hardened steel are provided in spaced relation to the longitudinal axis to define a transverse axis about which the foot pedal rocks, though there is no pivot pin. This structure eliminates the need for bushings and their associated long-term wear issues. Excessive wear causes the neutral tolerance range of a pedal to expand outside of the programmed limits.

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

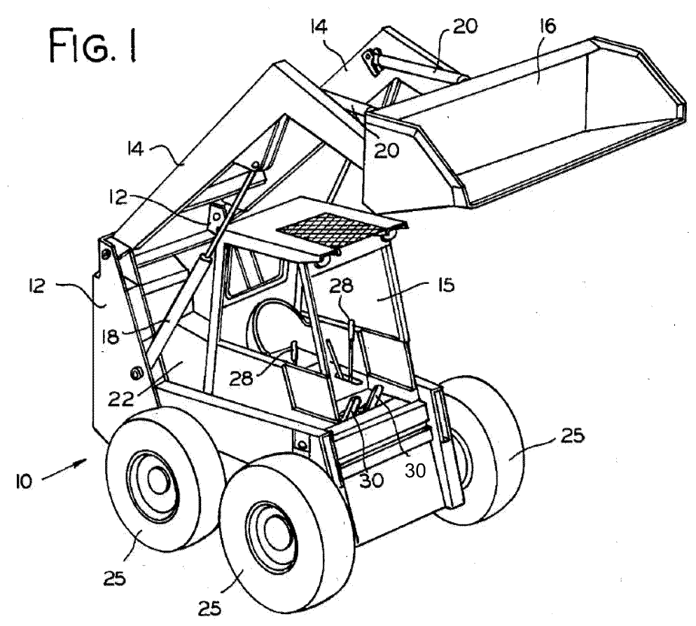

FIG. 1 is a front perspective view of an exemplary power machine on which a pedal of the current disclosure can be used, wherein the power machine is configured as a skid-steered loader 10 having a pair of uprights 12 at the rear and a pair of boom arms 14 pivotally connected to the uprights 12 and extending forwardly alongside an operator's compartment 15. Boom arms 14 pivotally mount an attachment, in this case a bucket 16, on an attachment carrier (not shown). A pair of hydraulic cylinders 18 mounted between the uprights 12 and boom arms 14 may be extended, as depicted in FIG. 1, for raising the boom arms 14 or retracted for lowering the arms. Other hydraulic cylinders 20 mounted between the arms 14 and the attachment carrier may be operated to pivot the carrier to dump or roll back the bucket 16. The vehicle is powered by an engine or electric battery 22 mounted toward the rear. The engine or battery 22 drives the wheels 25 on opposite sides of the vehicle in either forward or reverse directions, or at the same or different speeds, as controlled by controls such as joysticks or steering levers 28 that independently control separate left and right side transmissions, drive motors or other mechanisms. Thus the left and right side wheels 25 are driven independently to steer or maneuver in a manner known as skid-steering.

The vehicle 10 can include a hydraulic system pressurized by a pump driven off of the engine or battery 22 and controlled by a valve operated from foot pedals 30 in the operator's compartment for extending or retracting the boom cylinders 18 and likewise the tilt cylinders 20. More information about an example hydraulic control valve and its operation are provided in commonly owned U.S. Pat. No. 3,866,700 for “Tractor vehicle with hydrostatic drive means,” which is hereby incorporated by reference. Briefly, the control valve contains several valve sections, each having a valve spool that is spring biased to a neutral position. One valve spool controls the boom cylinders 18 while another controls tilt cylinders 20. One pedal 30 (such as the one on the right as illustrated) is connected to the valve spool controlling the boom cylinders 18 such that when pushed downward at the toe, the spool will be shifted from the neutral position in one direction, causing the cylinders 18 to lower the boom. When pushed downward at the heel, the valve spool will shift in the opposite direction from neutral for extending the cylinders 18 to raise the boom as shown in FIG. 1. Similarly, the other pedal 30 (such as the one on the left as illustrated) is connected to another valve spool for extending and retracting the tilt cylinders 20 to pivot the attachment carrier of bucket 16. While pedal 30 described below is used to implement these example functions in an exemplary embodiment of vehicle or power machine 10, in other power machines pedal 30 can be used to control other functions.

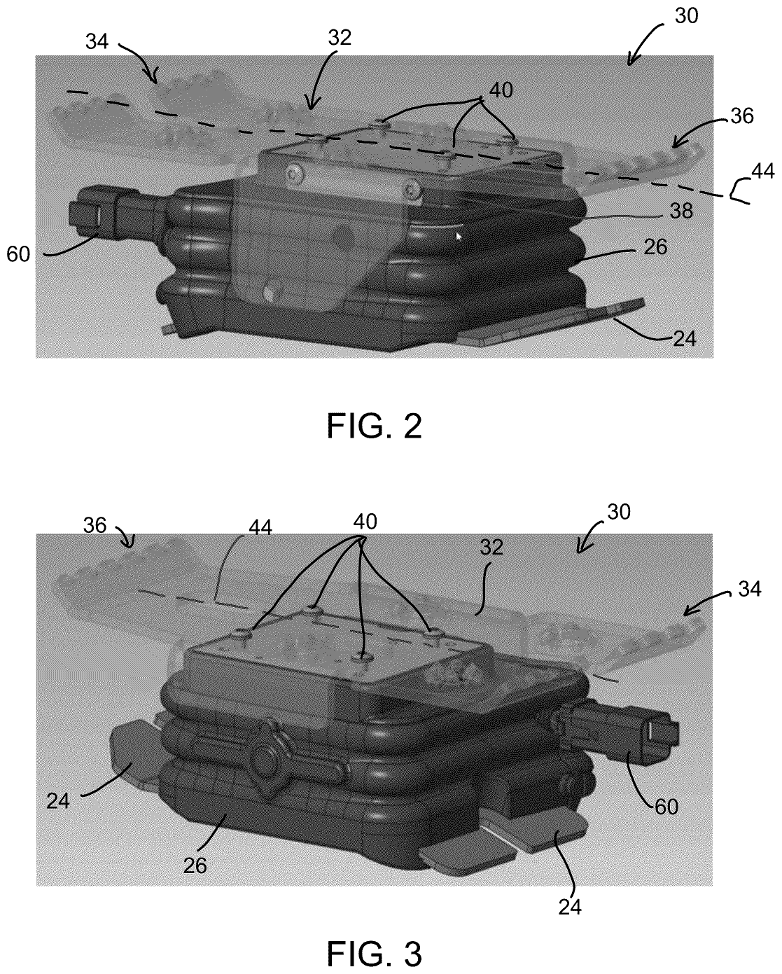

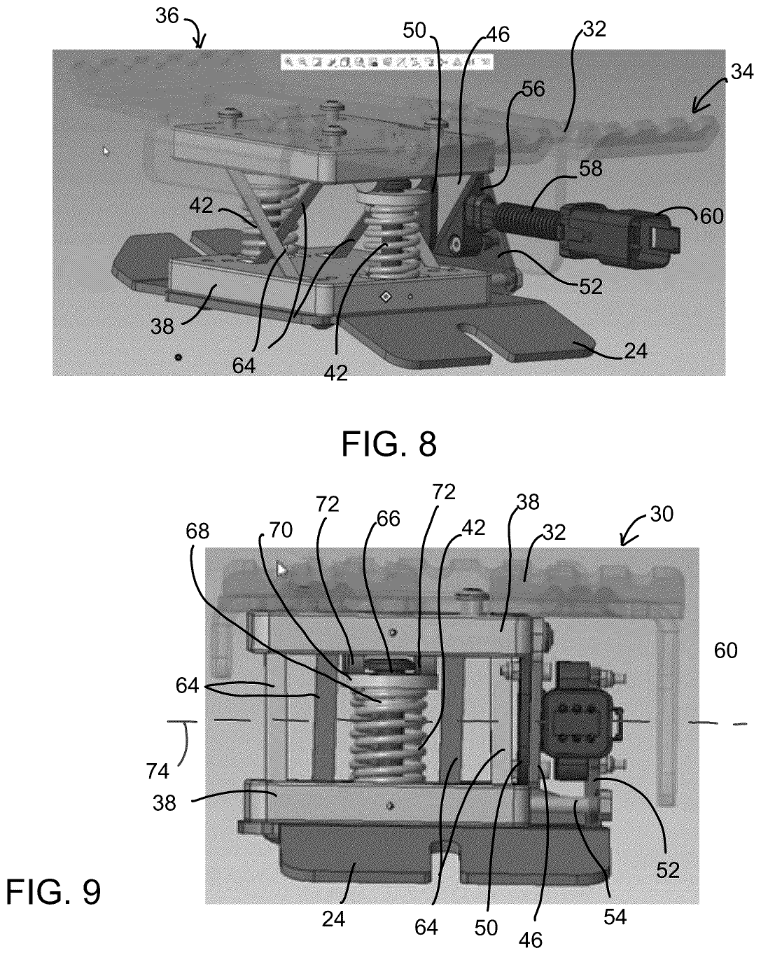

FIGS. 2-13 are views of an exemplary pivotless foot pedal 30. In an exemplary embodiment, mounting bracket 24 is secured to a floor support in the operator's compartment 15. FIGS. 2 and 3 are left and right perspective views, respectively, of an exemplary foot pedal 30 of the disclosure, with an optional protective boot 26. In an exemplary embodiment, boot 26 is formed of a flexible material such as rubber or polymeric elastomer with a flexible accordion-like structure that allows for flexing when the treadle 32 is pushed by the user's foot at the toe end 34 or heel end 36. The boot protects the internal components of pedal 30 from debris, moisture and other contaminants in harsh environments.

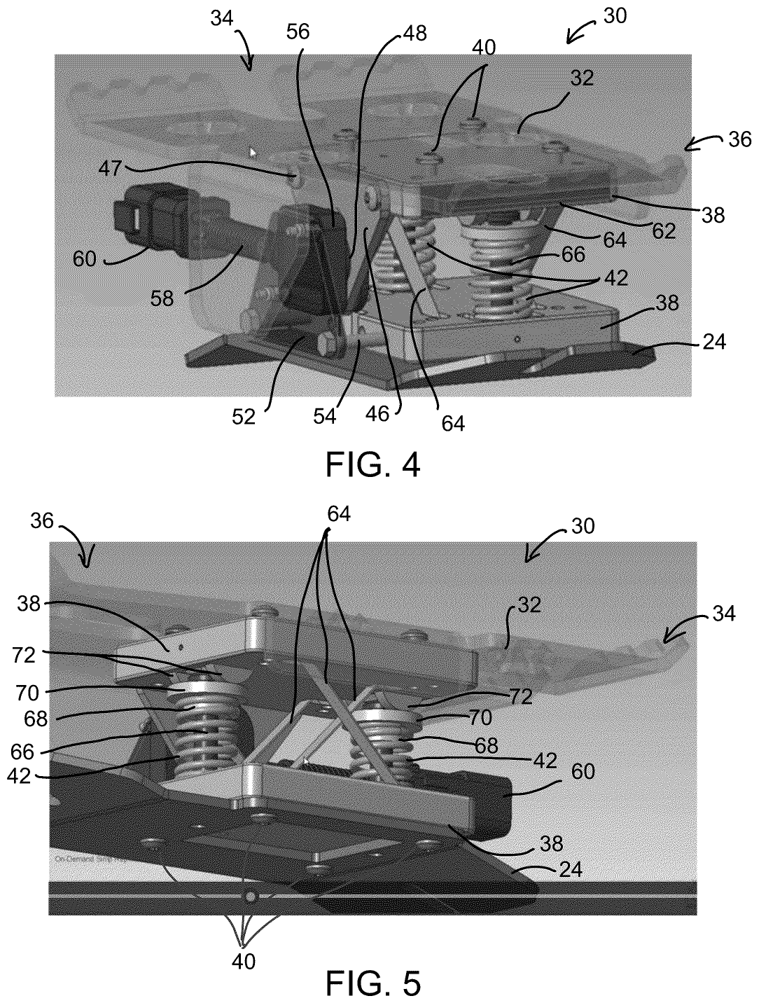

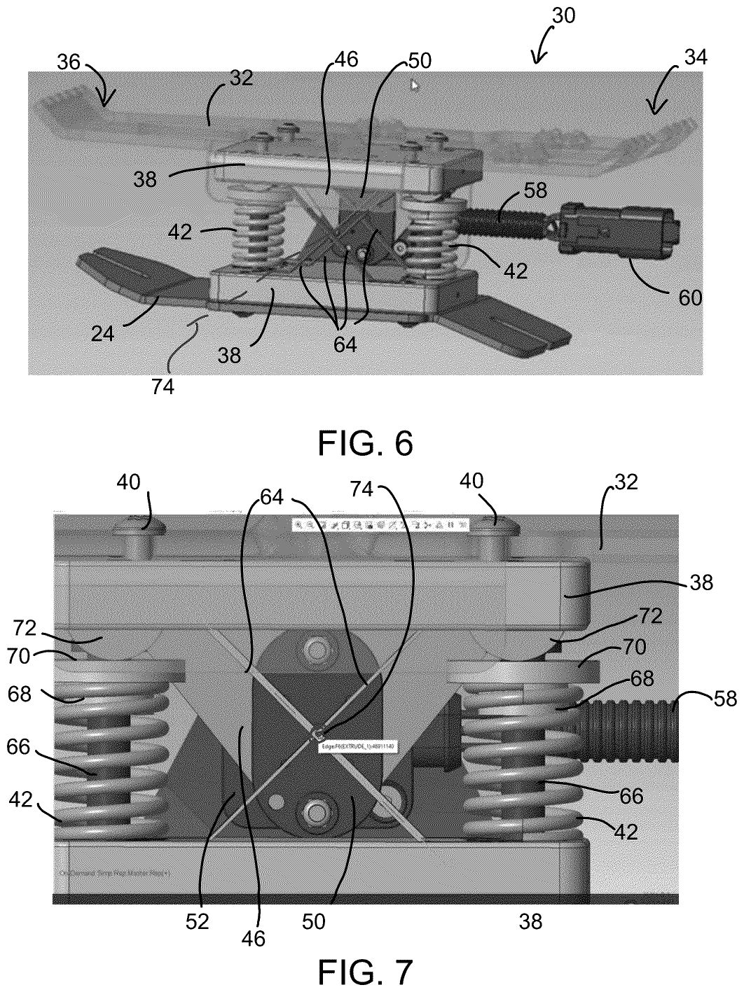

FIG. 4 is a left perspective view and FIG. 5 is a lower right perspective view, respectively, of the exemplary foot pedal, with the boot removed and some parts shown as transparent. FIG. 6 is a right side perspective view of the exemplary foot pedal, and FIG. 7 is an enlarged view of a portion of the right side of the exemplary foot pedal. A bottom base 38 is attached to mounting bracket 24 by fasteners 40. Similarly, a top base 38 is attached to treadle 32 by fasteners 40. In an exemplary embodiment, two compression springs 42 are provided along a longitudinal center line 44 of the pedal 30. In another embodiment, more than two compression springs 42 may be used, preferably symmetrically placed relative to longitudinal center line 44.

Magnet plate 46 is attached to the top base 38 by fasteners 47. Magnet plate 46 carries magnet 48 on one side and magnet pick-up 50 on the opposite side. Sensor plate 52 is attached to the bottom base 38 by fasteners 54. Sensor plate 52 carries sensor 56, to which is connected conduit 58 to carry wires of connector 60. In an exemplary embodiment, sensor 56 is a Hall Effect sensor, and a sensor trigger element 62 can be positioned on the heel end of top base 38, for example, to measure its motion. A gap is disposed between magnet 48 and sensor 56, so that there is no contact and thus no wear interface in the sensor assembly. In other embodiments, other types of sensors and sensed elements can be used. Therefore, sensor 56 and magnet 48 can be considered to include other types of sensors and other types of sensed components, elements or features.

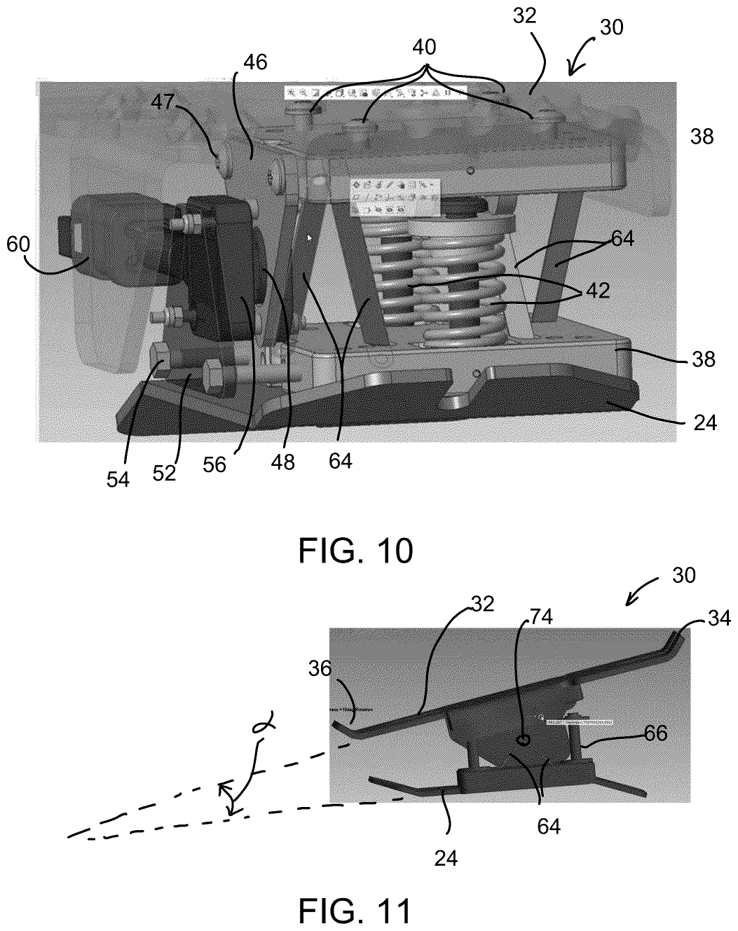

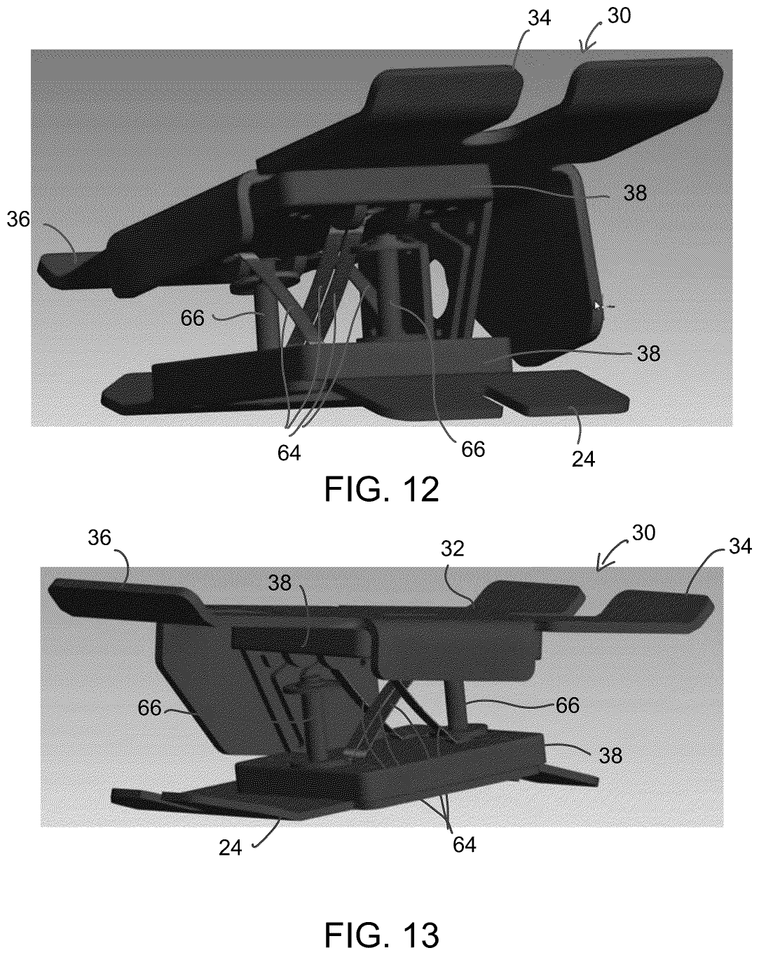

Flexures 64 in the form of hardened steel flat springs are disposed equidistantly on both sides of longitudinal center line 44 to constrain motion of the treadle 32 to a rocking or rotational motion about an effective or artificial axis 74, which moves slightly due to bending of the flexures 64 but is substantially centered about the cross point (as viewed from the side, as in FIGS. 7 and 11) of the two oppositely inclined flexures 64 on each side of longitudinal center line 44. In FIGS. 9 and 10, all the flexures 64 are placed on one side or the other of compression springs 42. However, in the embodiment shown in FIGS. 12 and 13, the inner flexures 64 are placed essentially between the compression springs 42. In both cases, the placement of flexures 64 is symmetrical about longitudinal center line 44.

Each compression spring 42 surrounds a spring shaft 66 that is fixed at its bottom end to the bottom base 38 and accepts at its top end the locating shoulder 68 of a spring plate 70. The spring shaft 66 axially constrains its respective compression spring 42. Semicircular cams 72 exert a pre-load force on the spring plate 70 in opposition to the spring force of the compression springs 42, resulting in an expected resistance or “pedal feel.” With motion of the treadle 32 either heel-down (FIGS. 11 and 12) or toe-down (FIG. 13), the arcuate bottom faces of the cams 72 rock along the top surface of spring plate 17. Theoretically, the only points of wear would be attributed to spring fatigue of the compression springs 42, spring fatigue of the flexures 64, and the contact interface between cams 72 and spring plates 70. Material selection for these components can be optimized to provide for durability and longevity. A particularly suitable material is hardened steel.

The spring forces of the compression springs 42 and flexures 64 can be chosen to provide the desired force characteristics for pedal 30 so that it moves in either the toe-push direction (FIG. 13) or the heel-push direction (FIGS. 11 and 12) when activated by an operator, and return to the neutral position (as shown in FIGS. 2-10) when the force of the user's foot is released (in which the flexures 64 are relatively straight). The vast majority of the spring effort is from the compression springs 42. The flat springs or flexures 64 contribute a small amount of force that is not usually considered when measuring pedal performance targets. Rather, the primary function of the flexures 64 is to constrain motion of the treadle 32 so that it has a rocking motion about an artificial transverse rotation axis 74 that behaves functionally like a pivot but does not have the same long-term wear issues as a conventional pivot assembly.

FIGS. 11 and 12 are right side and right distal end views, respectively, of the exemplary foot pedal 30 in rearward (heel-down) inclination at an angle alpha of about 10 degrees between the major surface of treadle 32 and the major surface of mounting bracket 24. FIG. 13 is a right proximal end view of the exemplary foot pedal in a 10 degree forward (toe-down) inclination. The compression springs are not shown so that the flexures 64 and their bent shapes are more visible. In an exemplary embodiment, each pedal 30 statically sits at zero degrees, wherein treadle 32 is at the neutral position shown in FIGS. 2-10. Depending on which pedal 30 is relevant (the pedal 30 that controls the boom arms 14 or the pedal 30 that controls the bucket 16 tilt), an operator for example can move the pedal 10 degrees full backwards (see FIGS. 11 and 12) to lift the arm up and then 10 degrees full forward (see FIG. 13) to put it down or vice versa.

As discussed, embodiments of the foot pedal operator input device include the foot pedal 30 having a sensor 56 and a sensed component 48. A top base 38 supports a treadle 32 apart from a bottom base 38. Oppositely inclined flexures 64 extend between the bottom base and the top base. The oppositely inclined flexures are configured to constrain motion of the treadle to a rocking or rotational motion about an artificial axis, instead of about a physical pivot mechanism, with the rocking or rotational motion of the treadle changing positioning between the sensor and the sensed component such that a sensor output is indicative of the treadle position. The oppositely inclined flexures, which can be steel flat springs for example, are configured and arranged such that the artificial axis is substantially centered about a cross point of the oppositely inclined flexures.

In exemplary embodiments, the oppositely inclined flexures 64 include pairs of oppositely inclined flexures on each side of a longitudinal center line 44 of the foot pedal. Also, the foot pedal can include at least two compression springs 42 extending between the bottom base and the top base. The compression springs are provided along the longitudinal center line of the foot pedal in some exemplary embodiments, and are positioned symmetrically relative to the longitudinal center line of the foot pedal in some embodiments. The foot pedal 30 can also include at least two spring shafts 66 and at least two spring plates 70, with each of the at least two compression springs surrounding one of the spring shafts extending from the bottom base to one of the spring plates at an end of the spring shaft. For each spring shaft and spring plate, the foot pedal includes a cam 72 supported by the top base and positioned such that an arcuate bottom face of the cam rocks along a top surface of the corresponding spring plate during the rocking or rotational motion of the treadle.

Although the subject of this disclosure has been described with reference to several embodiments, workers skilled in the art will recognize that changes may be made in form and detail without departing from the scope of the disclosure. In addition, any feature disclosed with respect to one embodiment may be included in another embodiment, and vice-versa. All references mentioned in this disclosure are hereby incorporated by reference.

What is claimed is:

1. A foot pedal operator input device for a power machine, the foot pedal comprising:
a sensor;
a sensed component;
a bottom base;
a top base;
a treadle supported by the top base; and
oppositely inclined flexures extending between the bottom base and the top base, the oppositely inclined flexures constraining motion of the treadle to a rocking or rotational motion about an artificial axis, the rocking or rotational motion of the treadle changing positioning between the sensor and the sensed component such that a sensor output is indicative of the treadle position.

2. The foot pedal of claim 1, wherein the oppositely inclined flexures include pairs of oppositely inclined flexures on each side of a longitudinal center line of the foot pedal.

3. The foot pedal of claim 2, and further comprising at least two compression springs extending between the bottom base and the top base.

4. The foot pedal of claim 3, wherein the at least two compression springs are provided along the longitudinal center line of the foot pedal.

5. The foot pedal of claim 3, wherein the at least two compression springs comprise a plurality of compression springs positioned symmetrically relative to the longitudinal center line of the foot pedal.

6. The foot pedal of claim 3, wherein the foot pedal further comprises at least two spring shafts and at least two spring plates, wherein each of the at least two compression springs surrounds one of the spring shafts extending from the bottom base to one of the spring plates at an end of the spring shaft, the foot pedal further comprising at least two cams supported by the top base and positioned such that arcuate bottom faces of the cams rock along top surfaces of the spring plates during the rocking or rotational motion of the treadle.

7. The foot pedal of claim 1, wherein the oppositely inclined flexures are configured and arranged such that the artificial axis is substantially centered about a cross point of the oppositely inclined flexures.

8. The foot pedal of claim 1, wherein the oppositely inclined flexures comprise oppositely inclined flat springs.

9. The foot pedal of claim 1, and further comprising a mounting bracket to which the bottom base is attached, the mounting bracket configured to mount the foot pedal in the power machine.

10. The foot pedal of claim 1, wherein the oppositely inclined flexures are configured to allow the rocking or rotational motion of the treadle without a pivot connection on the treadle or upper plate.

11. The foot pedal of claim 1, wherein the sensed component is a magnet and the sensor is a magnetic sensor.

12. The foot pedal of claim 11, wherein the sensor is a Hall Effect Sensor.
